(19) United States
(12) Patent Application Publication
(10) Pub. No.: US 2006/0180407 A1
(43) Pub. Date: Aug. 17, 2006

(54) Switch device of elevator

(76) Inventor: Jae Ho Lee, Allendale, NJ (US)

Correspondence Address: MCCARTER & ENGLISH, LLP, FOUR GATEWAY CENTER, 100 MULBERRY STREET, NEWARK, NJ, 07102, US

(21) Appl. No.: 11/315,806

(22) Filed: Dec. 22, 2005

(30) Foreign Application Priority Data
Dec. 24, 2004 (KR) 10-2004-0111644

(51) Int. Cl. B66B 1/16

(52) U.S. Cl. 187/380

(57) ABSTRACT

A foot button device of an elevator is disclosed. The foot button device is installed in a side of an elevator door to call the elevator, and includes foot buttons installed in a region where user's feet reach from a bottom such that the user pushes the foot buttons with a user's foot.

### CROSS-REFERENCE TO RELATED APPLICATION

This application claims the priority of Korean Patent Application No. 10-2004-0111644 filed Dec. 24, 2004, the disclosure of which is incorporated herein by reference in its entirety for all purposes.

### BACKGROUND OF THE INVENTION

1. Field of the Invention

The present invention relates to a switch device of an elevator, and more particularly, to a switch device of an elevator adapted to be actuated by a foot of a user.

2. Description of the Related Art

FIG. 1 is a perspective view illustrating a door of a conventional elevator and its peripherals. As shown in FIG. 1, the conventional elevator is structured such that in order to ride the elevator, one presses a button (i.e., a switch) 20 and waits for the arrival of the elevator. Then, one rides the elevator when the door 10 is opened.

Thus, the elevator is an apparatus used in hospitals, airports, schools, apartments, factories, hotels, government offices, or the like by many people. However, since people press the buttons with their hands, due to this, pathogenic organisms may be disseminated and people may be infected with the pathogenic organisms.

Particularly, in hospitals and schools in which there are many patients and the old and the weak, in order to prevent infection due to the dissemination and the contamination of the pathogenic organisms, disinfection and cleaning should be performed frequently, and especially, this is seriously affected according to seasons such as hot summer season and monsoon season.

Thus, common people hate to push the buttons of the elevator in the hospitals with their hands, and particularly, this phenomenon is more serious in the hospitals closely related to infection such as pediatrics (for example, meningitis, or the like), ophthalmology (for example, eye disease), and internal medicine (for example, influenza, Escherichia coli, bird influenza, or the like).

Moreover, even the buttons of the elevators used in the airports, hotels, or the like, since many foreigners use the elevators, people are exposed to the risk of being infected with endemic disease or by bacteria. Additionally, for one rides an elevator with luggage in both hands such as airports, hotels, or the like, there is inconvenience that one puts the luggage down, pushes the button of the elevator, and picks up the luggage again.

### SUMMARY OF THE INVENTION

Therefore, the present invention has been made in view of the above and/or other problems, and it is a first object of the present invention to provide a foot button device of an elevator pushed with a foot to prevent infection with various bacteria or with disease by pushing the button with hands.

It is a second object of the present invention to provide a foot button device of an elevator allowing one to push the buttons of the elevator without putting luggage down when holding the luggage with both hands.

In accordance with the present invention, the above and other objects can be accomplished by the provision of a foot button (i.e., switch) device of an elevator installed in a side of an elevator door to call the elevator and including foot buttons installed in a region where user's feet reach from a bottom such that the user pushes the foot buttons with a foot.

Preferably, the foot buttons are installed in the bottom near the elevator door such that the user pushes the foot buttons with a foot.

The foot buttons may be installed in the lower side of a wall near the elevator door such that the user pushes the foot buttons with a foot.

The foot buttons may be installed in the lower side of guide walls connected to the elevator door.

Preferably, the foot buttons include an ascending foot button and a descending foot button.

### BRIEF DESCRIPTION OF THE DRAWINGS

These and/or other objects and advantages of the present invention will become apparent and more readily appreciated from the following description of the embodiments, taken in conjunction with the accompanying drawings, in which:

FIG. 1 is a perspective view illustrating a door of a conventional elevator and its peripherals;

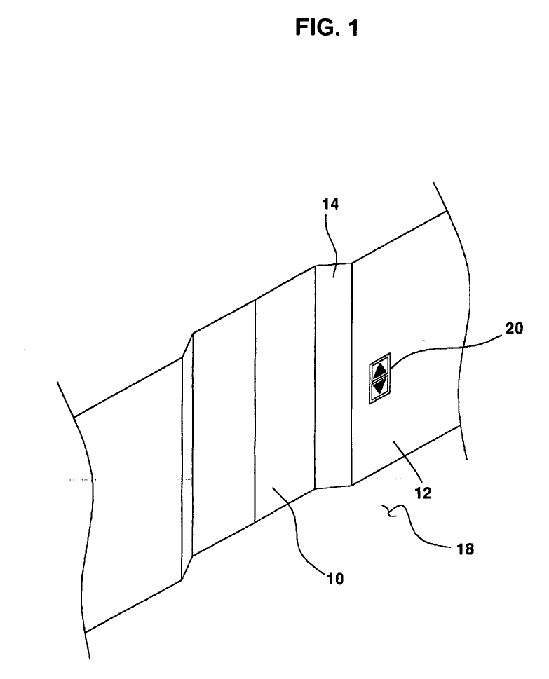

FIG. 2 is a perspective view illustrating a foot button device of an elevator according to a first preferred embodiment of the present invention;

FIG. 3 is a perspective view illustrating a foot button device of an elevator according to a second preferred embodiment of the present invention;

FIG. 4 is a perspective view illustrating a foot button device of an elevator according to a third preferred embodiment of the present invention;

FIG. 5 is a perspective view illustrating a foot button device of an elevator according to a fourth preferred embodiment of the present invention; and

FIG. 6 is a perspective view illustrating a foot button device of an elevator according to a fifth preferred embodiment of the present invention.

### DESCRIPTION OF THE PREFERRED EMBODIMENTS

Hereinafter, the structure of a foot button device of an elevator according to preferred embodiments of the present invention will be described in detail with reference to the attached drawings.

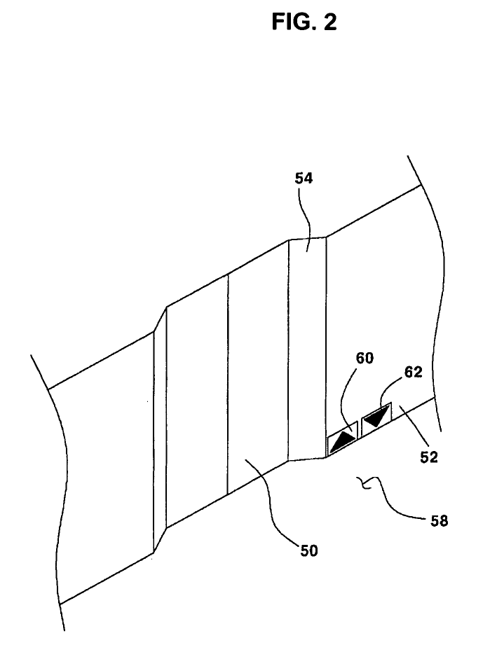

FIG. 2 is a perspective view illustrating the foot button device of an elevator according to a first preferred embodiment of the present invention. As shown in the drawing, the foot button device according to the first preferred embodiment of the present invention roughly includes an elevator door 50, guide walls 54, a wall 52, an ascending button (i.e., switch) 60, a descending button (i.e., switch) 62, and a bottom 58.

In other words, in the passage defined the bottom 58 and the wall 52, the elevator door 50 is installed, and between the elevator door 50 and the wall 52, the guide walls 54 inclined toward the lateral sides of the elevator door 50 are installed.

As shown in FIG. 2, the ascending button 60 and the descending button 62 are installed in the lower side of the wall 52 near the elevator door 50. The structure of the buttons 60 and 62 may be already known to those skilled in the art. However, preferably, the buttons 60 and 62 have a large size to push with a foot easily and light on and off to recognize easily the buttons are pushed. For example, each the buttons 60 and 62 is high about 20 cm and wide about 30 cm, and the ascending button 60 is spaced apart from the descending button 62 by about 5 cm. This is to provide for user convenience, as they must push the buttons 60 and 62 with their feet. Although both the ascending button 60 and the descending button 62 is installed as depicted in FIG. 2, one of the buttons 60 and 62 may be installed if necessary.

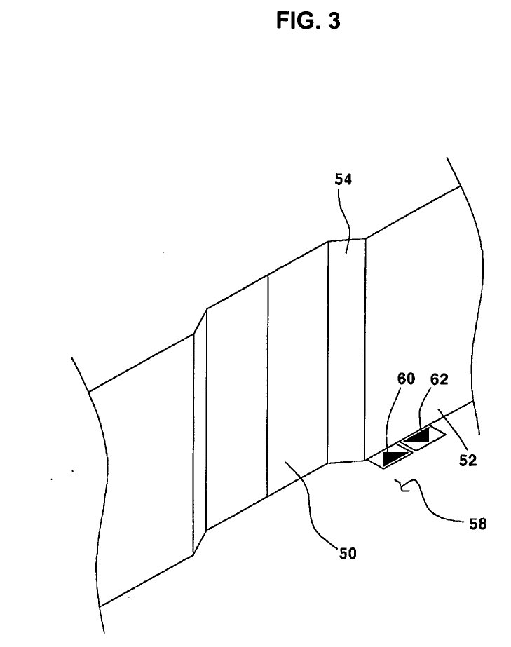

FIG. 3 is a perspective view illustrating a foot button device of an elevator according to a second preferred embodiment of the present invention. As shown in FIG. 3, the buttons 60 and 62 are installed in the bottom 58 near the elevator door 50. Thus, the buttons 60 and 62 are not pushed by people passing through the passage, but so one waiting in front of the elevator can push the buttons 60 and 62 easily. As such, the buttons 60 and 62 installed in the bottom 58 are preferably waterproofed in preparation for water cleaning and dust permeation.

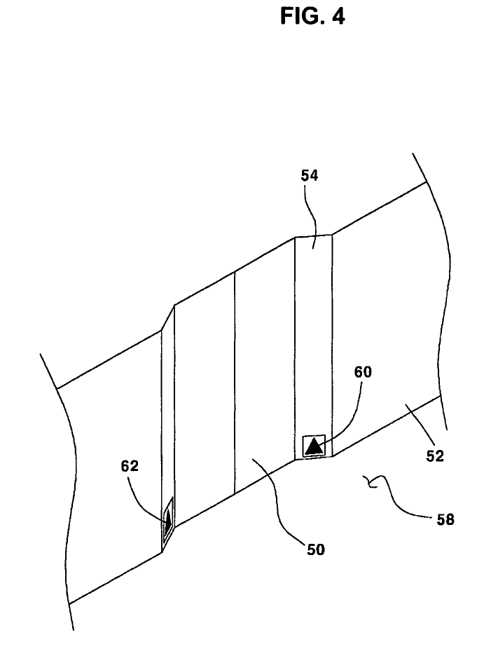

FIG. 4 is a perspective view illustrating a foot button device of an elevator according to a third preferred embodiment of the present invention. As shown in FIG. 4, the ascending button 60 is installed in the lower side of one of the guide walls 54 and the descending button 62 is installed in the lower side of the other of the guide walls 54. In this case, the buttons 60 and 62 never interfere with the walker passing through the passage and the rider can easily find and push the buttons 60 and 62. Although the buttons 60 and 62 are respectively installed in the guide walls 54, the ascending button 60 may be installed in one of the guide walls 54 and the descending button 62 may installed in the other of the guide walls 54.

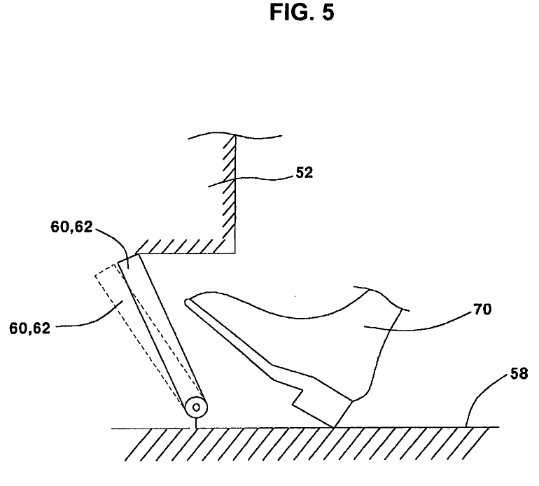

FIG. 5 is a perspective view illustrating a foot button device of an elevator according to a fourth preferred embodiment of the present invention. As shown in FIG. 5, the ascending button 60 and the descending button 62 are embedded in the wall 52, wherein the buttons 60 and 62 are structured like a pedal. Thus, when pushing the buttons 60 and 62 with a foot, the buttons 60 and 62 are pressed like the dotted line buttons 60 and 62 to be switched.

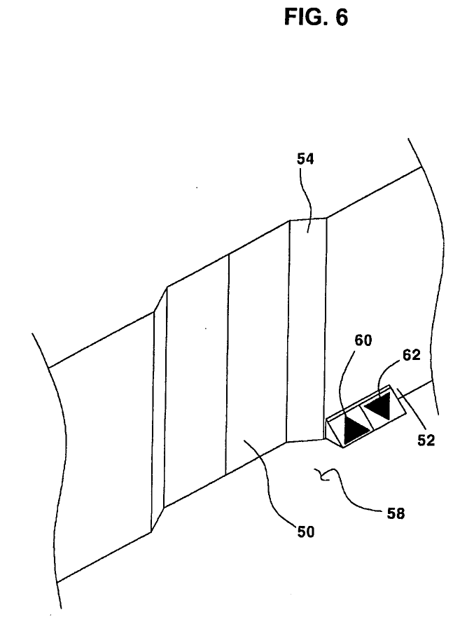

FIG. 6 is a perspective view illustrating a foot button device of an elevator according to a fifth preferred embodiment of the present invention. As shown in FIG. 6, the buttons 60 and 62 are inclined between the wall 52 and the bottom 58 to expose. The buttons 60 and 62 are biotechnologically designed so that one easily pushes the buttons 60 and 62 with a foot.

Although the buttons in the first, second, third, fourth, and fifth preferred embodiments of the present invention are easily understood by those skilled in the art, in more detail, the buttons may be the pressing buttons, the touch buttons, and the static electric buttons, and are structured enough to increase the size of the conventional buttons. Moreover, since wiring to the bottom is also easily performed by those skilled in the art, the description and the installation thereof will be omitted.

As described with respect to the buttons in the first, second, third, fourth, and fifth preferred embodiments of the present invention, the buttons of an elevator according to the present invention are installed within the height from the bottom to where a user's feet reach as high as possible. In more detail, preferably, the buttons are installed within the level from the bottom 30 cm, and more preferably, the nearer to the bottom the buttons are installed, the more convenient the buttons are used.

According to the foot button device of an elevator in accordance with the present invention, the foot buttons are pushed with a foot so that infection by various bacteria and disease can be prevented.

Moreover, even holding luggage with both hands, the buttons can be pushed without putting luggage down.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A switch device of an elevator installed in a side of an elevator door to call the elevator, comprising:
foot buttons installed in a region where user's feet can reach from a bottom such that a user can push the buttons with a foot.

2. The switch device of an elevator as set forth in claim 1, wherein the foot buttons are installed in the bottom near the elevator door such that the user pushes the foot buttons with a foot.

3. The switch device of an elevator as set forth in claim 1, wherein the foot buttons are installed in the lower side of a wall near the elevator door such that the user pushes the foot buttons with a foot.

4. The switch device of an elevator as set forth in claim 1, wherein the foot buttons are installed in the lower side of guide walls connected to the elevator door.

5. The switch device of an elevator as set forth in any one of claims 1 to 4, wherein the foot buttons comprise an ascending foot button and a descending foot button.

6. The switch device of an elevator as set forth in any one of claims 1 to 4, wherein the foot buttons comprise an ascending foot button or a descending foot button.
